(19) United States
(12) Patent Application Publication
(10) Pub. No.: US 2023/0259936 A1
(43) Pub. Date: Aug. 17, 2023

(54) SYSTEM AND METHOD FOR USING INTELLIGENT CODES IN CONJUNCTION WITH NON-FUNGIBLE TOKENS

(71) Applicant: BLACKHAWK NETWORK, INC., Pleasanton, CA (US)

(72) Inventor: Tristan Roffey, Pleasanton, CA (US)

(73) Assignee: BLACKHAWK NETWORK, INC., PLEASANTON, CA (US)

(21) Appl. No.: 18/107,111

(22) Filed: Feb. 8, 2023

Related U.S. Application Data
(60) Provisional application No. 63/309,089, filed on Feb. 11, 2022.

(51) Int. Cl. G06Q 20/40; G06Q 20/20

(52) U.S. Cl. CPC G06Q 20/401; G06Q 20/208

(57) ABSTRACT

A system and method of transacting a prepaid non-fungible token with an electronic mobile device that is used to electronically interface with a code, such as a QR code, bar code, RF signal or NFC signal, representing a prepaid product. The codes of multiple prepaid non-fungible tokens are grouped together on a single structure or in a single computer displayed in a shopping area. The electronic mobile device subsequently electronically interfaces with a point of sale device after electronically interfacing with said code to provide prepaid non-fungible token information.

### CROSS-REFERENCE TO RELATED APPLICATION

This application claims priority to U.S. Provisional Patent Application Ser. No. 63/309,089, filed Feb. 11, 2022, which is incorporated by reference herein in its entirety.

### FIELD OF THE INVENTION

The disclosure generally relates to the purchase of non-fungible tokens.

### BACKGROUND

A non-fungible token (“NFT”) is a digital asset that represents real-world objects like art, music, in-game items and videos. NFTs can be bought and sold online and are generally encoded with an underlying software. NFTs are generally one of a kind, or at least one of a very limited run, and have unique identifying codes. Many NFTs include digital creations that already exist in some form elsewhere, such as video clips or securitized versions of digital art. The NFT allows a buyer to own the original item with a built-in authentication that serves as proof of ownership. Each NFT has a digital signature that makes it impossible for NFTs to be exchanged for or equal to one another, thereby making the NFTs non-fungible. Purchasing an NFT requires a digital wallet that allows the purchaser to store the NFT. NFTs are generally purchased over marketplaces using cryptocurrency.

NFTs are based on a decentralized, distributed immutable ledger, e.g. blockchain, that records the provenance of a digital asset. By inherent design, the data on the ledger is unable to be modified. The shared, immutable ledger facilitates the process of recording transactions and tracking assets in a business network. An asset on the ledger can be tangible, e.g. a house, car, cash, or land, or intangible, e.g. intellectual property, patents, copyrights, or branding. Generally, NFTs on the ledger, e.g. blockchain-based tokens, each represent a unique asset like a piece of art, digital content, or media. Virtually anything of value can be tracked and traded on the ledger, reducing risk and cutting costs for all involved.

An NFT provides an irrevocable digital certificate of ownership and authenticity for a given asset, whether digital or physical. NFTs are designed to be cryptographically verifiable, unique or scarce, and easily transferable. Leveraging cryptographic signatures native to the ledger on which an NFT is issued, the origin and the current owner of the asset can be determined. An NFT is created by an artist, creator, or license-holder through a process called minting that involves signing a ledger transaction to outline the fundamental token details. These details are then broadcasted to the ledger to create the NFT and assign the NFT to its owner. What today's consumers need is a more efficient, secure, and effective way of acquiring NFTs.

### SUMMARY

The present disclosure includes one or more of the features recited in the appended claims and/or the following features which, alone or in any combination, may comprise patentable subject matter.

According to a first aspect of the disclosed embodiments, a method is performed by a processor computer device having a processor and executable instructions stored on a non-transitory computer readable medium which, when executed by the processor, causes the processor computer device to perform the method. The method includes receiving, by the processor computer device, from a user device, a purchase request for a non-fungible token, wherein the non-fungible token is available from a digital shopping site. The method also includes transforming, by the processor computer device, information from the purchase request into a point-of-sale scannable barcode, wherein the point-of-sale scannable barcode comprises purchase information of the non-fungible token for purchasing the non-fungible token. The method also includes providing, by the processor computer device, the point-of-sale scannable barcode to the user device in response to the request. The method also includes receiving, by the processor computer device, a purchase verification for the non-fungible token, wherein the purchase verification is subsequent to, and generated in response to, a point-of-sale scan of the point-of-sale scannable barcode displayed on the user device at a retailer point-of-sale. The method also includes providing, by the processor computer device, the non-fungible token to a user or a third-party recipient in response to receiving the purchase verification.

In some embodiments of the first aspect, the digital shopping site can include a plurality of non-fungible token from a plurality of retailers. The method can also include validating the purchase request of the non-fungible token. Validation can include providing a code to the user device that is provided to the processor computer device and determining the code is valid. The purchase request can be received from the user that has accessed the digital shopping site by scanning an intelligent code with the user device. The intelligent code can include at least one of a barcode; a QR code; an arrangement of numerals, letters, symbols, images, and/or colors; an electromagnetic signal (e.g., near field communication (“NFC”), infrared, radio frequency identification (“RFID”); a mechanical wave (e.g., sound); or combinations thereof. The intelligent code can be located at a retailer store which can include the retailer point of sale. The non-fungible token can be delivered digitally to an email or text number provided by the user. The method can also include receiving a purchase verification for the non-fungible token. The point-of-sale scannable barcode can be unique to the non-fungible token.

According to a second aspect of the disclosed embodiments, a system includes a computer device having a processor and executable instructions stored on a non-transitory computer readable medium, wherein the execution of the executable instructions configures the system to receive a scan of an intelligent code at a retailer store from a user device, wherein the scan of the intelligent code allows a user of the user device access to digital shopping site containing a plurality of electronic non-fungible tokens. The execution of the executable instructions also configures the system to receive a purchase request for a non-fungible token from the digital shopping site from a user device. The execution of the executable instructions also configures the system to transform information from the purchase request into a point-of-sale scannable barcode, wherein the point-of-sale scannable barcode comprises purchase information of the non-fungible token for purchasing the non-fungible token. The execution of the executable instructions also configures the system to provide the point-of-sale scannable barcode to the user device in response to the request. The execution of the executable instructions also configures the system to receive a purchase verification for the non-fungible token, wherein the purchase verification is subsequent to, and generated in response to, a point-of-sale scan of the point-of-sale scannable barcode displayed on the user device. The execution of the executable instructions also configures the system to provide the non-fungible token to the user of the user device or a third-party recipient in response to receiving the purchase verification.

In some embodiments of the second aspect, the digital shopping site can include a plurality of retailers. The execution of the executable instructions can also configure the system to receive a purchase verification for the non-fungible token. The execution of the executable instructions can also configure the system to receive a purchase request from the user that has accessed the digital shopping site by scanning an intelligent code with the user device. The intelligent code can include at least one of a barcode; a QR code; an arrangement of numerals, letters, symbols, images, and/or colors; an electromagnetic signal (e.g., near field communication (“NFC”), infrared, radio frequency identification (“RFID”); a mechanical wave (e.g., sound); or combinations thereof. The intelligent code can be on an endcap, a physical card, a card package, a chit, or combinations thereof. The point-of-sale scannable barcode can be unique to the non-fungible token. The execution of the executable instructions can also configure the system to deliver the non-fungible token digitally to an email or text number provided by the user. The execution of the executable instructions can also configure the system to provide a code to the user device that is provided to the processor computer device. The execution of the executable instructions can also configure the system to determine the code is valid.

According to a third aspect of the disclosed embodiments, a method is performed by a processor computer device. The processor computer device has a processor and executable instructions stored on a non-transitory computer readable medium which, when executed by the processor, causes the processor computer device to perform the method. The method includes receiving, by the processor computer device, a purchase request, in response to a scan of a point-of-sale scannable code, wherein the purchase request comprises a physical object request and a non-fungible token request, and, wherein a non-fungible token associated with the non-fungible token request includes a digital version of the a physical object associated with the physical object request. The method also includes verifiying, by the processor computer device, payment for the purchase request. The method also includes activating, by the processor computer device, a redemption code associated with the non-fungible token to produce an activated redemption code. The method also includes providing, by the processor computer device, the activated redemption code redeemable for the non-fungible token.

In some embodiments of the third aspect, the processor computer device can provide the non-fungible token to a user in response to activation of the activated redemption code. Upon verifying payment for the purchase transaction, the processor computer device can convert the point-of-sale scannable code into the activated redemption code. The activated redemption code can be unique to the non-fungible token. The activated redemption code can include at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof. The point-of-sale scannable code can include at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof. The physical object can include a trading card. The point-of-sale scannable code can be provided on a package of a plurality of trading cards. The activated redemption code can be redeemable for a plurality of non-fungible tokens, wherein each of the plurality of non-fungible tokens is a digital version of one of the plurality of trading cards. The method can include providing, by the processor computer device, a plurality of unique activated redemption codes, wherein each of the plurality of unique activated redemption codes is redeemable for one of a plurality of non-fungible tokens, wherein each of the plurality of non-fungible tokens is a digital version of one of the plurality of trading cards.

According to a fourth aspect of the disclosed embodiments, a method is performed by a processor computer device. The processor computer device has a processor and executable instructions stored on a non-transitory computer readable medium which, when executed by the processor, causes the processor computer device to perform the method. The method includes receiving, by the processor computer device, a purchase request for a non-fungible token in response to a scan of a point-of-sale scannable code. The method also includes verifiying, by the processor computer device, payment for the non-fungible token. The method also includes activating, by the processor computer device, a redemption code associated with the non-fungible token to produce an activated redemption code. The method also includes providing, by the processor computer device, the activated redemption code redeemable for the non-fungible token. In some embodiments of the fourth aspect, the processor computer device can provide the non-fungible token to a user in response to activation of the redemption code. Upon verifying payment for non-fungible token, the processor computer device can convert the point-of-sale scannable code into the activated redemption code. The redemption code can be unique to the non-fungible token. The redemption code can include at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof. The point-of-sale scannable code can include at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof. The point-of-sale scannable code can be associated with a plurality of non-fungible tokens. The activated redemption code can be redeemable for the plurality of non-fungible tokens. The method can include further providing, by the processor computer device, a plurality of unique activated redemption codes, wherein each of the plurality of unique activated redemption codes is redeemable for one of a plurality of non-fungible tokens. The point-of-sale scannable code can be displayed on a physical object. The physical object can be selected from a group including a chit, a manufactured card, an electronic display, or combinations thereof. The point-of-sale scannable code can be provided by a physical object. The physical object can include a device which emits an electromagnetic signal. The electromagnetic signal can be selected from a group including near field communication, infrared, radio frequency identification, or combinations thereof.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

FIG. 1 is a flowchart depicting an embodiment of a method for providing a non-fungible token via a code scan.

FIG. 2 is a flowchart depicting another embodiment of a method for providing a non-fungible token via a code scan.

FIG. 3A is a schematic illustration of an embodiment of a system for providing a non-fungible token via a code scan.

FIG. 3B is a schematic illustration of another embodiment of a system for providing a non-fungible token via a code scan.

FIG. 4 is a flowchart depicting another embodiment of a method for providing a non-fungible token via a code scan.

FIG. 5 is a flowchart depicting yet another embodiment of a method for providing a non-fungible token via a code scan.

### DETAILED DESCRIPTION

Disclosed herein are systems and methods for acquiring non-fungible tokens (hereinafter “NFT” or “NFTs”). Particularly, the systems and methods disclosed herein may provide an NFT in response to a user request (hereinafter “NFT Request”). In an embodiment, the NFT Request comprises an NFT identifier (hereinafter “intelligent code”). In an embodiment, the intelligent code comprises a barcode; a QR code; an arrangement of numerals, letters, symbols, images, and/or colors; an electromagnetic signal (e.g., near field communication (“NFC”), infrared, RFID); a mechanical wave (e.g., sound); or combinations thereof. In an embodiment, the intelligent code is may be interpreted, scanned, input, and/or read (“scan” may be used to reference any of the foregoing) by a user's device via voice recognition, camera manipulation, physical gesture (e.g., finger swipe), NFC communication, Bluetooth communication, or other known methods for engaging a user's device for information reception. The intelligent code may be conveyed, transmitted, delivered, or otherwise communicated to an NFT provider and/or distribution system via phone line, cellular communication, Wi-Fi communication, Bluetooth communication, radio communication, USB, MiniPin, email, webpage interaction, internet communication, VoIP, short message service (“SMS”), Instant messaging, infrared communication, Android Beam, or other methods of communication known to those of skill in the art.

As used herein, “non-fungible token” or “NFT” refers to a digital asset that represents real-world objects like art, music, in-game items and videos. NFTs can be bought and sold online and are generally encoded with an underlying software. NFTs are generally one of a kind, or at least one of a very limited run, and have unique identifying codes. Many NFTs include digital creations that already exist in some form elsewhere, such as video clips or securitized versions of digital art. The NFT allows a buyer to own the original item with a built-in authentication that serves as proof of ownership.

In embodiments, before the user obtains (e.g., receives, activates redeems, or combinations thereof) the NFT, the NFT provider, the e-wallet provider, the NFT processor, the NFT issuer, the merchant, or combinations thereof may provide fraud mitigation. In an embodiment, providing fraud mitigation may comprise blocking access to an NFT before a user views the NFT, blocking access to an NFT before a user activates or redeems the NFT, or both. In an additional or alternative embodiment, providing fraud mitigation may comprise determining a digital fingerprint of a user device (e.g., user device 14), at the time a user attempts to view an NFT to determine the risk associated with the user, the NFT, or both. In an additional or alternative embodiment, providing fraud mitigation may comprise withholding the providing of the NFT (e.g., withholding the delivery of redemption information for the NFT). In an additional or alternative embodiment, providing fraud mitigation may comprise determining a geographic location of the NFT and/or user and pausing the providing of the NFT for a period of time determined by the geographic location. For example, the providing of the NFT may be held for a longer period of time in geographic locations known or determined to be of high risk of fraud, and the providing of the NFT may be held for a short period of time or for a period of time comprising zero in geographic locations known or determined to be of low or no risk of fraud.

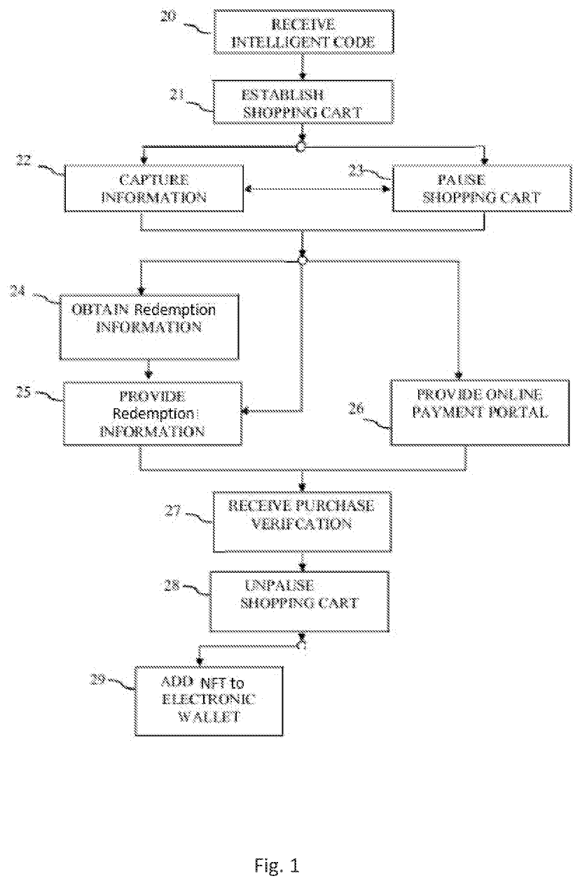

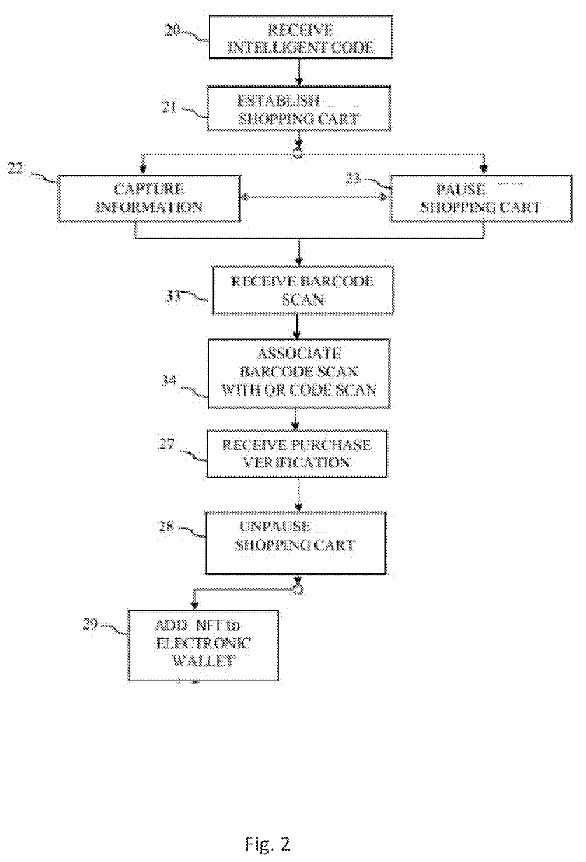

FIGS. 1 and 2 show flowcharts of embodiments of methods for providing an NFT via receipt of an intelligent code. The various steps of the methods may be omitted, substituted, and rearranged except where specified herein below. In an embodiment, the intelligent code may convey a request for multiple NFTs. Moreover, the two separate NFTs may be delivered to different recipients upon request. Moreover, the NFTs may also be subject to the fraud mitigation capabilities described above.

The method in FIG. 1 starts at block 20. At block 20, an intelligent code is received. The intelligent code is associated with a request for an NFT, a request for a tutorial for redeeming the NFT via an intelligent code, or both. That is, a request for an NFT may be conveyed via a transmission of an intelligent code, a tutorial for redeeming the NFT may be conveyed via a transmission of an intelligent code, or both may be conveyed by the transmission of one or more intelligent codes. As used herein, “redeeming” the NFT or “redemption” of the NFT refers to the delivery of the NFT in an activated usable state to a user, for example, the user's e-wallet upon activation of the intelligent code. “Redeeming” or “redemption” may also refer to the delivery of the NFT in an inactive unusable state to the user. In such a scenario, “redemption” of the NFT requires a further step of activating the NFT into the activated usable state. In an embodiment, the NFT Request may comprise additional user provided information (e.g., zip code of location) or additional user device provided information (e.g., geographic location information based on GPS or other locationing methods). The above-described additional information may be used by an NFT processor, an NFT issuer, or an NFT processor/issuer to filter NFT offerings available for the identified geographic location. In embodiments, the intelligent code may include information comprising NFT redemption information, retailer identification (e.g., store ID), NFT category, GPS coordinates of the user (e.g., of the merchant location and/or user's mobile device), type of user device (e.g., of the user's mobile device), identification of the user device, IP address, one or more email addresses, whether the request is for multiple NFTs, e-wallet account information (e.g., e-wallet login), where to deliver the NFT (e.g., a third-party via communication means described herein), whether the user wishes to purchase now or later, whether the user wishes to purchase in-store or online, other information known to those skilled in the art with the aid of this disclosure, or combinations thereof. In an embodiment, the intelligent code does not comprise information which can be used to redeem the NFT. A tutorial may comprise a ‘Try Me’ app where a user can scan an intelligent code and follow the various method steps without actually purchasing an NFT. The tutorial may alternatively comprise a website explaining how the intelligent code method works for obtaining an NFT. The tutorial may alternatively comprise a demo video of how to convey the intelligent code to obtain an NFT. The tutorial may additionally comprise a link to move the user to a live purchase of an NFT according to the embodiments disclosed herein.

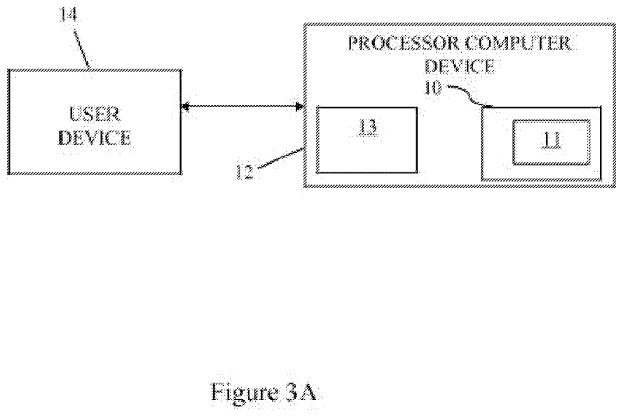

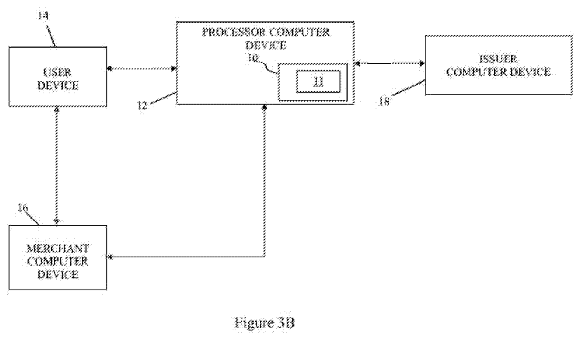

A customer or consumer of NFTs (also referred to herein as a “user” in the disclosed embodiments) may generally make the request for the NFT at a physical retail (e.g., merchant) location, an online merchant portal, via a user device (e.g., user device 14 of FIGS. 3A and 3B), or combinations thereof. A physical retail location or online merchant portal may have a physical or virtual “endcap” which is a display for the intelligent codes for various NFTs.

The request for an NFT may comprise a request to view a selection of NFTs available for purchase, a request to purchase an NFT (or multiple NFTs), or combinations thereof. In response to a request to view a selection of NFTs, an entity (e.g., an NFT processor, an NFT issuer, or an NFT processor/issuer) may provide the selection of NFTs available for purchase to the user, the selection of NFT values available to the user, NFT purchase information as described herein below, or combinations thereof.

At block 21 of FIG. 1, an NFT shopping cart is established. The NFT shopping cart may be established in response to the received intelligent code scan. The NFT shopping cart may comprise unredeemed NFTs associated with the received intelligent code scan. For example, after an NFT processor receives a QR code scan from a user, the NFT processor may create an NFT shopping cart which stores the QR code information identifying the NFT associated with the QR code. The NFT shopping cart may also associate any information captured in block 22 of the method of FIG. 1 with one or more NFTs therein. The NFT in the NFT shopping cart may comprise an unredeemed state. For example, as a digital representation of the NFT status on a device such as the user's mobile device, the NFT shopping cart may be shown as a webpage, popup window, app, or combinations thereof, and the NFT may be shown with a visual identifier. The visual identifier may be made transparent and/or without interactivity on the user's device to indicate the NFT is in the NFT shopping cart but not yet redeemed. In embodiments, the NFT shopping cart is not displayed to the user until the user purchases and redeems the NFT.

At block 22 of FIG. 1, information may be captured in response to the request for an NFT. In addition to information contained in the intelligent code, captured information may comprise GPS coordinates of the user (e.g., of the user's mobile device), type of user device (e.g., of the user's mobile device), identification of the user device, IP address, one or more email addresses, whether the request is for multiple NFTs, e-wallet account information (e.g., e-wallet login), where to deliver the NFT (e.g., a third-party via communication means described herein), whether the user wishes to purchase now or later, whether the user wishes to purchase in-store or online, other information known to those skilled in the art with the aid of this disclosure, or combinations thereof. In embodiments, the user may be prompted on a device (e.g., a user device) and asked to submit the information which is desirably captured. The user may enter and submit the information, may deny entering the information, may request to enter the information later, may take no action, or combinations thereof. In embodiments wherein the NFT shopping cart has not been paused before capturing information and pausing the NFT shopping cart is desired, flow may proceed from block 22 to block 23 of FIG. 1. In embodiments where the NFT shopping cart has already been paused or pausing is not desired, flow from block 22 of FIG. 1 may proceed to block 24 of FIG. 1; alternatively, to block 25 of FIG. 1; alternatively, to block 26 of FIG. 1.

At block 23 of FIG. 1, the NFT shopping cart may be paused. For example, the provider of the NFT shopping cart, e.g., the NFT processor or the NFT issuer, may pause further activity associated with the NFT shopping cart (in embodiments, other than adding more NFTs via intelligent code scan). In embodiments, activity associated with the NFT shopping cart may be paused until a condition is satisfied, such as a purchase of an NFT, a redemption of an NFT, or in one-step redemption scenarios, the purchase and redemption of the NFT. In embodiments where information is not captured before pausing the NFT shopping cart and captured information is desired, flow proceeds to block 22 of FIG. 1. In embodiments where information has already been captured or is not desired, flow may proceed to block 24 of FIG. 1; alternatively, to block 25 of FIG. 1; alternatively, to block 26 of FIG. 1.

In the disclosed embodiments, the user may choose (e.g., via a prompt embodied as a selection screen, popup window, which can be prompted while entering information at block 22 of FIG. 1, etc.) to purchase the NFT via in-store purchase (e.g., via a point-of-sale device) or via an online payment portal (e.g., provided by a computer device of the NFT processor which acts as an online merchant for the purchase of the NFT, of a third-party merchant, or of an NFT issuer which acts as an online merchant for the purchase of the NFT). In embodiments, the user may automatically be taken to online payment unless the user elects not to purchase online, or the NFT may automatically be prepared (e.g., according to blocks 24 and 25) for in-store purchase unless the user elects not to purchase in-store. In embodiments, the user may use a user device to request the online purchase without need for a point-of-sale device, e.g., via an online payment portal, or the user may use the user device to elect in-store payment for the NFT. If the user requests online payment, flow may proceed to block 26. If the user elects to pay in-store, flow may proceed to block 24 or block 25 depending on which entity (e.g., NFT processor or NFT issuer) provides the barcode and redemption information for the NFT. In embodiments, the user may choose not to purchase at the time of prompting, and the NFT shopping cart may remain paused as discussed in block 23 until further action is taken (e.g., in-store purchase of the NFT, online purchase of the NFT, deletion of the NFT from the NFT shopping cart, etc.).

At block 24 of FIG. 1, purchase information (e.g., a barcode and/or redemption information) for the NFT purchase is obtained. In embodiments, purchase information is obtained after the user chooses to purchase the NFT in-store. In an embodiment, the entity processing the purchase of the NFT (i.e., via the initiating intelligent code scan) may not be the same entity as the issuer of the NFT. The processing entity may obtain the barcode and/or redemption information of the requested NFT from another entity such as the issuer of the NFT. The issuer of the NFT may generate, or retrieve a pre-generated, unique barcode and/or redemption information for purchase of the NFT. The barcode may comprise an EAN128 barcode, a dynamic EAN128 barcode, or a UPC. Redemption information may comprise a redemption code. In an embodiment, the barcode comprises the redemption information in an issuer account portion of the barcode. Additionally the barcode comprises a vendor product identification in a vendor product identification portion of the barcode.

At block 25 of FIG. 1, purchase information (e.g., a unique barcode and/or unique redemption information) for the NFT purchase is provided (e.g., made available for retrieval, sent via digital communication, etc.). In an embodiment where the entity processing the purchase of the NFT (i.e., via the initiating intelligent code scan) may be the issuer of the NFT, the processing entity may generate, or retrieve a pre-generated, unique barcode and/or redemption information for purchase of the NFT. The NFT processor may then provide (e.g., send) the barcode and/or redemption information to the user (e.g., via user device), to a merchant (e.g., via a merchant computer device, described in the discussion for FIG. 3B), or combinations thereof. In an embodiment where the processor of purchase of the NFT is an entity separate from the issuer of the NFT and the issuer is responsible for providing barcode and/or redemption information, the issuer of the NFT may provide (e.g., send) the barcode and/or redemption information to the processor of the NFT (e.g. for forwarding to the user), directly to the user (e.g., via a user device), to the merchant (e.g., via a merchant computer device, described in the discussion for FIG. 3B), or combinations thereof. After performing the step at block 25 of FIG. 1, flow may proceed to block 28 of FIG. 1.

At block 26 of FIG. 1, an online payment portal may be provided. In embodiments, an online payment portal may be provided (e.g., by the NFT processor acting as a merchant, or by a third-party merchant) to the user through which the user may purchase the NFT. The online payment portal may request payment information (e.g., account number, expiration date, security code) for a credit/debit card. The user, e.g., via the user device, may enter the payment information (e.g., credit/debit card number, billing address (postal code), expiration date, security code, or combinations thereof) and the payment information may be processed by the NFT processor (in embodiments where the NFT processor provides the payment portal), or by a third-party merchant that forwards the payment information to the NFT processor.

At block 27 of FIG. 1, purchase verification is received. The purchase verification may comprise a redemption request of the NFT. In embodiments where the NFT is purchased in-store, the barcode may be sent to and displayed on a user device (e.g., the user's mobile device), and the user may scan the barcode displayed on the user device (or have the barcode scanned by in-store personnel) with a merchant computer device (e.g., a point-of-sale terminal of a merchant). Scanning the barcode and redemption information may be considered a one-step redemption method, as opposed to a two-step redemption method where the barcode and redemption information are separately provided and purchase of the NFT is a separate step from redemption of the NFT. The one-step redemption of the NFT embodied by scanning the barcode and redemption information may comprise simultaneously or serially (e.g., one after another without separate request) scanning the barcode and redemption information (e.g., comprising a redemption code, a vendor product identification, an issuer account code, or combinations thereof) at a merchant computer device (e.g., point-of-sale terminal). One-step redemption of the NFT only requires a single entry by a clerk operating the point-of-sale terminal to redeem the NFT. For example, the one step may be performed at the point-of-sale terminal by scanning the barcode, (e.g., an EAN/UCC-128 barcode) comprising both a vendor product identification portion and an issuer account portion. The vendor product identification portion may be used to perform a look-up to determine NFT identity and price, or may contain the NFT identity and price without need for merchant look-up. The issuer account portion may be used to redeem the particular account associated with the NFT such that the NFT may be used (e.g., viewed, listened to, or otherwise interacted with). Upon being entered at the point-of-sale terminal, the issuer account portion may be conveyed (for example, via a network described herein below) to, and received by, the issuer of the NFT (e.g., as a purchase verification and/or a redemption request); the issuer account portion may be conveyed (for example, via a network described herein below) to, and received by, the processor of the NFT (e.g., as a purchase verification and/or as a redemption request); the issuer account portion may be conveyed (for example, via a network described herein below) to, and received by, a third-party NFT processor responsible for delivering the NFT (e.g., as a purchase verification and/or as a redemption request); or combinations thereof. Once the purchase verification and/or redemption request is received, the processor, issuer, third-party processor, or combinations thereof, may deliver the NFT via methods known in the art with the aid of this disclosure.

In embodiments with an online purchase of the NFT, the barcode may not be provided. In online purchase embodiments, when the online payment portal requests payment information (e.g., account number, expiration date, security code) for a credit/debit card, the user, e.g., via the user device, may enter the payment information (e.g., credit/debit card number, billing address (postal code), expiration date, security code, or combinations thereof) and the payment information may be processed by the NFT processor (in embodiments where the NFT processor provides the payment portal), or by a third-party merchant that forwards the payment information to the NFT processor. Upon online payment, a purchase verification may be conveyed (for example, via a network described herein below) to, and received by, the issuer of the NFT (e.g., as a purchase verification and/or a redemption request); the purchase verification may be conveyed (for example, via a network described herein below) to, and received by, the processor of the NFT (e.g., as a purchase verification and/or as a redemption request); the purchase verification may be conveyed (for example, via a network described herein below) to, and received by, a third-party NFT processor responsible for delivering the NFT (e.g., as a purchase verification and/or as a redemption request); or combinations thereof.

Once the purchase verification and/or redemption request is received, the processor, issuer, third-party processor, or combinations thereof, may deliver the NFT via methods known in the art with the aid of this disclosure. In embodiments, the purchase of the NFT may be processed by the provider of the NFT and/or e-wallet (e.g., via NFT processor), by a merchant, by the NFT issuer, or combinations thereof. In an embodiment, the purchase may be processed by applying a purchase value to complete the transaction. In an embodiment, identifying authentication information may comprise authentication techniques known to those skilled in the art with the aid of this disclosure. In embodiments, processing the purchase may further comprise processing at least a portion of the purchase in a primary wallet of an e-wallet (e.g., electronic wallet 10 of FIG. 3A), processing at least a portion of the purchase in a sub-wallet of an e-wallet (e.g., of electronic wallet 10 of FIG. 3A), or both. In embodiment, a notification may be sent to the user, merchant, processor, and or issuer that the purchase has been processed. After performing an embodiment of the step at block 27 of FIG. 1, flow may proceed to block 28 of FIG. 1.

At block 28 of FIG. 1, the NFT shopping cart is unpaused. In embodiments, the NFT shopping cart is unpause after purchase of an NFT contained therein, after redemption of an NFT therein, or both. In embodiments, the NFT shopping cart is unpaused only for the NFT purchased and/or redeemed while the NFT shopping cart remains paused for non-purchased and/or unredeemed NFTs.

At block 29 of FIG. 1, the purchased and redeemed NFT may be added to an electronic wallet (e.g., of the user). As used herein, an “electronic wallet” (also referred to as “e-wallet”) may include an electronically maintained data file (e.g., maintained on a computer device of a provider of the electronic wallet, for example, the NFT processor) which may comprise pre-existing NFTs, and authentication information, sub-wallets (e.g., for separately maintaining NFT-related information). The NFT processor may prompt the user (e.g., before or after redemption of the NFT) whether the user would like to create an electronic wallet and add the NFT thereto, or whether the user has a pre-existing e-wallet and would like to add the NFT thereto. The processor may add the redeemed NFT to an e-wallet designated by the user upon instruction by the user, or automatically according to preferences in the e-wallet which may be recognized in embodiments where the use purchases the NFT from the user's e-wallet provider or in another arrangement where the e-wallet provider may recognize the purchase of the NFT which needs to be automatically added to the user's e-wallet.

The method in FIG. 2 starts at block 20. The method of FIG. 2 utilizes a chit or physical card located on an endcap. A physical retail location or online merchant portal may have a physical or virtual “endcap” which is a display for the intelligent codes for various NFTs. The endcap may also have racks which hold one or more chits. A chit may comprise cardboard, plastic, or other material suitable for display on an endcap. In embodiments, the chit may hang on a rack of the endcap. The chit may comprise an intelligent code, a barcode, or both. In embodiments where the chit comprises a barcode, the intelligent code may be displayed on the endcap display. In embodiments where the chit comprises a barcode and intelligent code, the intelligent code may not be displayed on the endcap display.

In the method of FIG. 2, blocks 20, 21, 22, and 23 are the same steps of the method of blocks 20, 21, 22, and 23 of FIG. 1, except that the method of FIG. 2 utilizes chits, for example, located on an endcap, to provide NFTs.

At block 20 of FIG. 2, an intelligent code scan is received. The intelligent code scan is associated with a request for an NFT, a request for a tutorial for redeeming the NFT via an intelligent code scan, or both. That is, a request for an NFT may be received via an intelligent code scan, a tutorial for redeeming the NFT may be received via an intelligent code scan, or both may be received by one or more intelligent code scans. As set forth above, “redeeming” the NFT or “redemption” of the NFT refers to the delivery of the NFT in an activated usable state to a user, for example, the user's e-wallet upon activation of the intelligent code. “Redeeming” or “redemption” may also refer to the delivery of the NFT in an inactive unusable state to the user. In such a scenario, “redemption” of the NFT requires a further step of activating the NFT into the activated usable state. The intelligent code may include information comprising retailer identification (e.g., store ID), NFT category, application data known to those of skill in the art with the aid of this disclosure, or combinations thereof. In an embodiment, the intelligent code does not comprise information which can be used to redeem an NFT. The tutorial may comprise the tutorial embodiments discussed for block 20 of FIG. 1.

A user may generally make the request for the NFT at a physical retail (e.g., merchant) location, an online merchant portal, via a user device (e.g., user device 14 of FIGS. 3A and 3B), or combinations thereof. A physical retail location or online merchant portal may have a physical or virtual endcap which displays the intelligent codes and barcodes for various brands and/or values of NFTs. In embodiments, the endcap may have chits which have no magnetic stripe and/or value in themselves but which display the intelligent code, the barcode, or both. For example, the intelligent code may comprise a general intelligent code and be displayed on the endcap display itself, and the barcode may be unique to the NFT and displayed on the chit (e.g., wherein the chit is placed on the endcap (e.g., via a rack) and can be disposed of after purchase of the NFT). In another example, the intelligent code may comprise a general or unique intelligent code and be displayed on the chit which is placed on the endcap (e.g., via a rack), and the barcode may be unique to the NFT and likewise displayed on the chit (e.g., wherein the chit is placed on the endcap (e.g., via a rack) and can be disposed of after purchase of the NFT).

At block 21 of FIG. 2, an NFT shopping cart is established. The NFT shopping cart may be established in response to the received intelligent code scan. The NFT shopping cart may comprise unredeemed NFTs associated with the received intelligent code scan. For example, after an NFT processor receives the intelligent code scan from a user, the NFT processor may create an NFT shopping cart which stores the intelligent code information identifying the NFT associated with the intelligent code. The NFT shopping cart may also associate any information captured in block 22 of the method of FIG. 2 with one or more NFTs therein. The NFT in the NFT shopping cart may comprise an unredeemed state. For example, as a digital representation of the NFT status on a device such as the user's mobile device, the NFT shopping cart may be shown as a webpage, popup window, app, or combinations thereof, and the NFT may be shown with a visual identifier. The visual identifier may be made transparent and/or without interactivity on the user's device to indicate the NFT is in the NFT shopping cart but not yet redeemed. In embodiments, the NFT shopping cart is not displayed to the user until the user purchases and redeems the NFT.

At block 22 of FIG. 2, information may be captured in response to the request for an NFT. In addition to information contained in the intelligent code, captured information may comprise GPS coordinates of the user (e.g., of the user's mobile device), type of user device (e.g., of the user's mobile device), identification of the user device, IP address, one or more email addresses, whether the request is for multiple NFTs, e-wallet account information (e.g., e-wallet login), where to deliver the NFT (e.g., a third-party via communication means described herein), whether the user wishes to purchase now or later, whether the user wishes to purchase in-store or online, other information known to those skilled in the art with the aid of this disclosure, or combinations thereof. In embodiments, the user may be prompted on a device (e.g., a user device) and asked to submit the information which is desirably captured. The user may enter and submit the information, may deny entering the information, may request to enter the information later, may take no action, or combinations thereof. In embodiments wherein the NFT shopping cart has not been paused before capturing information and pausing the NFT shopping cart is desired, flow may proceed from block 22 to block 23 of FIG. 2. In embodiments where the NFT shopping cart has already been paused or pausing is not desired, flow from block 22 of FIG. 2 may proceed to block 33 of FIG. 2.

At block 23 of FIG. 2, the NFT shopping cart may be paused. For example, the provider of the NFT shopping cart, e.g., the NFT processor or the NFT issuer, may pause further activity associated with the NFT shopping cart (in embodiments, other than adding more NFTs via intelligent code scan). In embodiments, activity associated with the NFT shopping cart may be paused until a condition is satisfied, such as a purchase of an NFT, a redemption of an NFT, or in one-step redemption scenarios, the purchase and redemption of the NFT. In embodiments where information is not captured before pausing the NFT shopping cart and captured information is desired, flow proceeds to block 22 of FIG. 2. In embodiments where information has already been captured or is not desired, flow may proceed to block 33 of FIG. 2.

At block 33 of FIG. 2, a barcode scan is received. In embodiments, the user may use a user device to scan the barcode (e.g., on the endcap display or on the chit). The barcode may comprise an EAN128 barcode, a dynamic EAN128 barcode, or a UPC. In embodiments, the barcode may comprise redemption information which may comprise a redemption code. In an embodiment, the barcode comprises the redemption information in an issuer account portion of the barcode. Additionally the barcode may comprise a vendor product identification in a vendor product identification portion of the barcode. When the user scans the barcode, the information contained on the barcode is transmitted to the NFT processor, NFT issuer, or a party which is both the processor and issuer of the NFT. In embodiments, the user is not the merchant and thus is not an authenticated party for which receipt of the barcode would trigger authentication of the NFT. In such embodiments, the party that receives the barcode scan (made by the user) may perform various activities with the information contained in the received barcode scan, for example, as described for block 34 of FIG. 2.

At block 34 of FIG. 2, the intelligent code scan is associated with the barcode scan (e.g., by the NFT processor, the NFT issuer, or both). In embodiments, the NFT processor, the NFT issuer, or a party that is both the issuer and processor of the NFT may associate the barcode scan with the intelligent code scan. For example, the party may gather the information for preparation of purchase and redemption of the unpurchased and/or unredeemed NFT in the NFT shopping cart established in block 21 of FIG. 2.

In the disclosed embodiments, the user may choose (e.g., via a prompt embodied as a selection screen, popup window, which can be prompted while entering information at block 22 of FIG. 2, etc.) to purchase the NFT via in-store purchase (e.g., via a point-of-sale device) or via an online payment portal (e.g., provided by a computer device of the NFT processor which acts as an online merchant for the purchase of the NFT, of a third-party merchant, or of an NFT issuer which acts as an online merchant for the purchase of the NFT). For example, after receipt of the barcode scan from the user, the user may be prompted to purchase the NFT by removing the chit from the endcap and take the chit to a point-of-sale device of the merchant for purchase and/or redemption of the NFT. In an alternative embodiment, after receipt of the barcode scan from the user, the user may be prompted to purchase the NFT via an online payment portal. In embodiments, the user may automatically be taken (e.g., after the barcode scan is received) to online payment unless the user elects not to purchase online, or the NFT may automatically be prepared (e.g., after the barcode scan is received) (e.g., according to blocks 24 and 25 of FIG. 1) for in-store purchase unless the user elects not to purchase in-store. In embodiments, the user may use a user device to request the online purchase without need for a point-of-sale device, e.g., via an online payment portal, or the user may use the user device to elect in-store payment for the NFT. If the user requests online payment, payment may be made according to the techniques described for block 26 of FIG. 1. If the user elects to pay in-store, the steps of block 24 and/or block 25 of FIG. 1 may be performed depending on which entity (e.g., NFT processor or NFT issuer) provides the barcode and redemption information for the NFT. In embodiments, the user may choose not to purchase at the time of prompting, and the NFT shopping cart may remain paused as discussed in block 23 of FIG. 2 until further action is taken (e.g., in-store purchase of the NFT, online purchase of the NFT, deletion of the NFT from the NFT shopping cart, etc.).

At block 27 of FIG. 2, a purchase verification is received. The purchase verification may comprise a redemption request of the NFT. In embodiments where the user elects to purchase the NFT in-store, the user at the physical endcap at a merchant location may remove the chit from the endcap display and take the chit comprising the barcode to a merchant computer device (e.g., a point-of-sale device having a barcode scanner). The clerk of the merchant may scan the barcode on the chit, and the processor of the NFT or issuer of the NFT may receive the barcode scan again, albeit from the merchant's point-of-sale device. Scanning the barcode and redemption information by the merchant may be considered a one-step redemption method, as opposed to a two-step redemption method where the barcode and redemption information are separately provided and purchase of the NFT is a separate step from redemption of the NFT. The one-step redemption of the NFT embodied by scanning the barcode and redemption information may comprise simultaneously or serially (e.g., one after another without separate request) scanning the barcode and redemption information (e.g., comprising a redemption code, a vendor product identification, an issuer account code, or combinations thereof) at a merchant computer device (e.g., point-of-sale terminal). One-step redemption of the NFT only requires a single entry by a clerk operating the point-of-sale terminal to redeem the NFT. For example, the one step may be performed at the point-of-sale terminal by scanning the barcode, (e.g., an EAN/UCC-128 barcode) comprising both a vendor product identification portion and an issuer account portion. The vendor product identification portion may be used to perform a look-up to determine NFT identity and price, or may contain the NFT identity and price without need for merchant look-up. The issuer account portion may be used to redeem the particular account associated with the NFT such that the NFT may be used (e.g., viewed, listened to, or otherwise interacted with). Upon being entered at the point-of-sale terminal, the issuer account portion may be conveyed (for example, via a network described herein below) to, and received by, the issuer of the NFT (e.g., as a purchase verification and/or a redemption request); the issuer account portion may be conveyed (for example, via a network described herein below) to, and received by, the processor of the NFT (e.g., as a purchase verification and/or as a redemption request); the issuer account portion may be conveyed (for example, via a network described herein below) to, and received by, a third-party NFT processor responsible for delivering the NFT (e.g., as a purchase verification and/or as a redemption request); or combinations thereof. Once the purchase verification and/or redemption request is received, the processor, issuer, third-party processor, or combinations thereof, may deliver the NFT via methods known in the art with the aid of this disclosure.

In embodiments with an online purchase of the NFT, the barcode on the chit may not be scanned again (e.g., by the merchant via a point-of-sale device). In lieu of a second barcode scan (e.g., by the merchant), the user may choose to purchase the NFT via an online payment portal as described herein. In online purchase embodiments, when the online payment portal requests payment information (e.g., account number, expiration date, security code) for a credit/debit card, the user, e.g., via the user device, may enter the payment information (e.g., credit/debit card number, billing address (postal code), expiration date, security code, or combinations thereof) and the payment information may be processed by the NFT processor (in embodiments where the NFT processor provides the payment portal), or by a third-party merchant that forwards the payment information to the NFT processor. Upon online payment, a purchase verification may be conveyed (for example, via a network described herein below) to, and received by, the issuer of the NFT (e.g., as a purchase verification and/or a redemption request); the purchase verification may be conveyed (for example, via a network described herein below) to, and received by, the processor of the NFT (e.g., as a purchase verification and/or as a redemption request); the purchase verification may be conveyed (for example, via a network described herein below) to, and received by, a third-party NFT processor responsible for delivering the NFT (e.g., as a purchase verification and/or as a redemption request); or combinations thereof.

Once the purchase verification and/or redemption request is received, the processor, issuer, third-party processor, or combinations thereof, may deliver the NFT via methods known in the art with the aid of this disclosure. In embodiments, the purchase of the NFT may be processed by the provider of the NFT and/or e-wallet (e.g., via NFT processor), by a merchant, by the NFT issuer, or combinations thereof. In an embodiment, the purchase may be processed by applying a purchase value to complete the transaction. In an embodiment, identifying authentication information may comprise authentication techniques known to those skilled in the art with the aid of this disclosure. In embodiments, processing the purchase may further comprise processing at least a portion of the purchase in a primary wallet of an e-wallet (e.g., electronic wallet 10 of FIG. 3A), processing at least a portion of the purchase in a sub-wallet of an e-wallet (e.g., of electronic wallet 10 of FIG. 3A), or both. In embodiment, a notification may be sent to the user, merchant, processor, and or issuer that the purchase has been processed. After performing an embodiment of the step at block 27 of FIG. 2, flow may proceed to block 28 of FIG. 2.

At block 28 of FIG. 2, the NFT shopping cart is unpaused. In embodiments, the NFT shopping cart is unpause after purchase of an NFT contained therein, after redemption of an NFT therein, or both. In embodiments, the NFT shopping cart is unpaused only for the NFT purchased and/or redeemed while the NFT shopping cart remains paused for non-purchased and/or unredeemed NFTs.

At block 29 of FIG. 2, the purchased and redeemed NFT may be added to an electronic wallet (e.g., of the user). As used herein, an “electronic wallet” (also referred to as “e-wallet”) may include an electronically maintained data file (e.g., maintained on a computer device of a provider of the electronic wallet, for example, the NFT processor) which may comprise pre-existing NFTs, and authentication information, sub-wallets (e.g., for separately maintaining NFT-related information). The NFT processor may prompt the user (e.g., before or after redemption of the NFT) whether the user would like to create an electronic wallet and add the NFT thereto, or whether the user has a pre-existing e-wallet and would like to add the NFT thereto. The processor may add the redeemed NFT to an e-wallet designated by the user upon instruction by the user, or automatically according to preferences in the e-wallet which may be recognized in embodiments where the use purchases the NFT from the user's e-wallet provider or in another arrangement where the e-wallet provider may recognize the purchase of the NFT which needs to be automatically added to the user's e-wallet.

FIG. 3A is a schematic illustration of an embodiment of a system according to the disclosure. As shown in FIG. 3A, an embodiment of the disclosed system for providing an NFT via an intelligent code scan may comprise a processor computer device 12 (e.g., of an NFT processor), a user device 14 (e.g., of a user), or combinations thereof.

The components of the system of FIG. 3A may be operably connected via one or more networks (e.g., broadband, optical, Wi-Fi, Bluetooth, NFC, cellular, satellite, cloud, card processing network, banking network, a local area network, the World Wide Web for Internet, non-cellular mobile phone network, a land-line network, Public Switched Telephone Network (PSTN), a dedicated communication line, other networks for transferring electronic information, or combinations thereof). Particularly, the user device 14 may be operably connected to the processor computer device 12 via the network, and vice-versa.

The user device 14 may comprise a personal computer, a tablet, a smartphone, a cloud computing system, a server, or combinations thereof. The device used by the user or consumer to purchase the NFT may be the same or different device from the user device 14. In an embodiment, the user may scan a QR code for an NFT using the user device 14. In an additional or alternative embodiment, the user may scan a barcode for an NFT using the user device 14. In an additional or alternative embodiment, the user or consumer may purchase an NFT using the user device 14 (e.g., via an online payment portal). In additional or alternative embodiments, the user may enter information required or requested for the purchase of an NFT using the user device 14.

The processor computer device 12 may have any suitable configuration for performing the functions disclosed herein (e.g., a personal computer, a tablet, a smartphone, a cloud computing system, a server, or combinations thereof). The processor computer device 12 may be a computer device of an NFT processor, and in additional embodiments, a provider of one or more electronic wallets (e.g., electronic wallet 10), a provider of an NFT (e.g., NFT 11), or both.

FIG. 3A shows the processor computer device 12 may comprise an electronic wallet 10. In embodiments, the processor computer device 12 may further comprise a database (e.g., database/datastore 180 as described for the figures herein below) to store one or more NFTs (e.g., NFT 11), one or more electronic wallets (e.g., electronic wallet 10), at least a portion of the information associated with each NFT (intelligent code information, barcode information, captured information from a user, or combinations thereof), or combinations thereof.

FIG. 3A shows an embodiment of the system comprising one electronic wallet 10. In alternative embodiments, the system may comprise a first electronic wallet and a second electronic wallet. In additional or alternative embodiments, the electronic wallet 10 may comprise any number of sub-wallets as described herein below. Electronic wallets (e.g., electronic wallet 10) may offer a variety of services, including storing, managing, and facilitating the redemption of value (e.g., monetary, discount, promotional, value tokens, rewards, etc.) of NFTs. One or more NFTs (e.g., NFT 11) may be associated (e.g., registered) with the one or more electronic wallets. For example, a first NFT (e.g., NFT 11) and a second NFT may be registered in electronic wallet 10. Alternatively, a first NFT (e.g., NFT 11) may be registered in a first electronic wallet and a second NFT may be registered in a second electronic wallet. In additional or alternative embodiments, one or more NFTs may be associated (e.g., registered) in a sub-wallet of an electronic wallet (registration techniques, methods, and processes are discussed herein below).

FIG. 3A also shows an embodiment of the processor computer device 12 comprising an online payment portal. The processor computer device 12 is configured to accomplish the embodiments of the methods disclosed hereinabove. In embodiments, the processor computer device 12 of FIG. 3A is configured to a receive a request for an NFT via an intelligent code scan; to receive a purchase verification for the NFT; to provide the NFT; to provide a barcode, redemption information, or both of the NFT in response to the request for an NFT; to obtain the barcode, the redemption information, or both from an issuer of the NFT in response to the request for an NFT; to receive a barcode scan for the NFT from a user device, and associate the intelligent code scan with the barcode scan; to receive a barcode scan for the NFT from a merchant computer device, and to deliver the NFT; to establish an NFT shopping cart upon receipt of the intelligent code scan, wherein the NFT is placed in the NFT shopping cart; to pause the NFT shopping cart; to unpause the NFT shopping cart; to add the NFT to an electronic wallet; to capture information as described for block 22 in FIGS. 1 and 2 (e.g., comprising a user email, a retailer identification, a GPS location, a device type, a device identification, an IP address, an NFT category, or combinations thereof); to provide an online payment portal for the NFT; or combinations thereof.

In embodiments, the processor computer device 16 may be configured to process at least a portion of an NFT purchase via a primary wallet of an electronic wallet 10, the merchant computer device 16 may be configured to process at least a portion of an NFT purchase via a sub-wallet of an electronic wallet 10, or both (primary wallets and sub-wallets are discussed herein below).

The processor computer device 12 may be configured to perform other functions as described above for the methods in FIGS. 1 and 2.

In the system of FIG. 3A, a user may initiate the purchase of an NFT via an intelligent code scan. The user may then proceed to purchase the NFT via online purchase, whether or not a chit or physical card is used.

In the system of FIG. 3A, a user may input an intelligent code with user device 14, which is sent automatically or via instruction from the user to the processor computer device 12. The processor computer device 12 may then establish an NFT shopping cart for the NFT associated with the intelligent code. The processor computer device 12 may then prompt the user for information to be entered via user device 14, may pause the NFT shopping cart, or both. The user may use the user device 14 to communicate with the processor computer device 12 with the user's preferred payment method or if the user would like to not make a purchase. The user may decide to purchase the NFT associated with the intelligent code. In the system embodiment of FIG. 3A, the user may purchase the NFT via an online payment portal 13 provided by the processor computer device 12. As described above, the user may go to the online payment portal and enter requested information (e.g., credit/debit card number, expiration date, security code, billing information) to complete the purchase of the NFT. The processor computer device 12 may then unpause the NFT shopping cart upon receipt of a purchase verification. The processor computer device 12 may deliver the NFT upon receipt of the purchase verification. The processor computer device 12 may then add the NFT to an e-wallet of the user, provide the NFT to the user device 14 or otherwise, or combinations thereof. In embodiments utilizing a chit or a physical card with a barcode as described hereinabove, the user device 14 may scan the barcode of the NFT, and the processor computer device 12 may receive the barcode scan and associate the intelligent code scan with the barcode scan, for example, to prepare the NFT for purchase and redemption in the NFT shopping cart.

FIG. 3B is a schematic illustration of another embodiment of a system according to the disclosure, shown a merchant computer device separate from the processor computer device. As shown in FIG. 3B, an embodiment of the disclosed system for providing an NFT via an intelligent code scan may comprise a processor computer device 12 (e.g., of an NFT processor), a user device 14 (e.g., of a user), a merchant computer device 16 (e.g., of a merchant), an issuer computer device 18 (e.g., of an issuer of an NFT), or combinations thereof.

The processor computer device 12 comprises a device separate from the issuer computer device 18, the merchant computer device 16, and the user device 14. In alternative embodiments, the processor computer device 13 may comprise a device which is the same device as merchant computer device 16, the issuer computer device 18, or both (as shown in FIG. 3A). While FIG. 3B shows one embodiment of a system according to the disclosure, it should be understood many system embodiments are disclosed. For example, many system embodiments may accomplish the embodiments of the methods for providing an NFT via an intelligent code disclosed hereinabove depending upon whether processor computer device 12 comprises the same or different computer device as the merchant computer device 16 and/or issuer computer device 18.

The components of the system of FIG. 3B may be operably connected via one or more networks (e.g., broadband, optical, Wi-Fi, Bluetooth, NFC, cellular, satellite, cloud, card processing network, banking network, a local area network, the World Wide Web for Internet, non-cellular mobile phone network, a land-line network, Public Switched Telephone Network (PSTN), a dedicated communication line, other networks for transferring electronic information, or combinations thereof). Particularly, the processor computer device 12 may be operably connected to the user device 14, the merchant computer device 16, the issuer computer device 18, or combinations thereof, via the network; the user device 14 may be operably connected to the processor computer device 12, the merchant computer device 16, the issuer computer device 18, or combinations thereof, via the network; the merchant computer device 16 may be operably connected to the user device 14, the processor computer device 12, the issuer computer device 18, or combinations thereof, via the network; the issuer computer device 18 may be operably connected to the user device 14, the processor computer device 12, the merchant computer device 16, or combinations thereof; or combinations thereof. When any of the computer devices 14, 16, or 18 of the system of FIG. 3B is operably connected to the processor computer device 12, said devices 14, 16, or 18 may additionally be operably connected to an e-wallet on the processor computer device 12.

The processor computer device 12 of FIG. 3B may comprise one of the embodiments of the processor computer device 12 of FIG. 3A.

The user device 14 of FIG. 3B may comprise one of the embodiments of the user device 14 described for FIG. 3A.

As seen in FIG. 3B, the merchant computer device 16 may comprise a computer device (e.g., a point-of-sale device of a merchant) separate from the processor computer device 12. The merchant computer device 16 may have any suitable configuration for performing the functions disclosed herein (e.g., a personal computer, a tablet, a smartphone, a cloud computing system, a server, or combinations thereof). In embodiments, the merchant computer device 16 may perform transactions with a computer device (e.g., user device 14) of a consumer, for example, in a purchase of an NFT. The merchant computer device 16 may communicate with the processor computer device 12 to complete a transaction with a user or consumer.

In embodiments, the merchant computer device 16 may be configured to provide an online payment portal, scan a barcode of an NFT (e.g., NFT 11) (e.g., displayed on a chit or on the user device 14), to communicate with the processor computer device 12 and/or issuer computer device 18 to process an NFT purchase, or combinations thereof.

As can be seen in FIG. 3B, the issuer computer device 18 may comprise a computer device separate from the processor computer device 12. The issuer computer device 18 may comprise a computer device of an issuer of an NFT (e.g., NFT 11). The issuer computer device 19 may have any suitable configuration for performing the functions disclosed herein (e.g., a personal computer, a tablet, a smartphone, a cloud computing system, a server, or combinations thereof). The issuer computer device 18 may be configured to generate a barcode for an NFT (e.g., NFT 11), to retrieve a pre-generated barcode for an NFT, to provide a barcode for an NFT to the processor computer device 12, to provide a barcode for an NFT to the user device 14, or combinations thereof.

In the system of FIG. 3B, a user may initiate the purchase of an NFT via an intelligent code scan. The user may then proceed in two paths to purchase, one for embodiments without a chit or physical card, and one for embodiments with a chit comprising a barcode or a physical card with a transmittable indicia.

In embodiments without a chit or a physical card, a user may scan an intelligent code with user device 14, which is sent automatically or via instruction from the user to the processor computer device 12. The processor computer device 12 may then establish an NFT shopping cart for the NFT associated with the intelligent code. The processor computer device 12 may then prompt the user for information to be entered via user device 14, may pause the NFT shopping cart, or both. The user may use the user device 14 to communicate with the processor computer device 12 with the user's preferred payment method or if the user would like to not make a purchase. The user may decide to purchase the NFT associated with the intelligent code. The user may purchase the NFT via an online payment portal 13 or via a merchant computer device 16 (e.g., a point-of-sale device). If the user elects an online purchase, the user may make a payment as discussed in the system of FIG. 3A and the methods hereinabove. If the user elects an in-store purchase, the processor computer device 12 may provide a barcode and/or redemption information to the user device 14, and the user device 14 is configured to display the barcode (e.g., via a screen of a mobile device). In an embodiment, the processor computer device 12 may communicate with another device (e.g., issuer computer device 18) to obtain the barcode and redemption information of the NFT 11. The user may then scan (or have scanned) the barcode displayed on the user device 14 with the merchant computer device 16 to make the purchase of the NFT. The purchase is processed as described hereinabove (e.g., by processor computer device 12), and a payment verification is received by the processor computer device 12. The processor computer device 12 may then unpause the NFT shopping cart. The processor computer device 12 may then add the NFT to an e-wallet of the user, provide the NFT to the user via user device 14 or otherwise, or combinations thereof.

In embodiment using a chit or physical card, the user may scan any intelligent code with user device 14, which is sent automatically or via instruction from the user to the processor computer device 12. The processor computer device 12 may then establish an NFT shopping cart for the NFT associated with the intelligent code. The processor computer device 12 may then prompt the user for information to be entered via user device 14, may pause the NFT shopping cart, or both. The user may use the user device 14 to communicate with the processor computer device 12 with the user's preferred payment method or if the user would like to not make a purchase. The user may decide to purchase the NFT associated with the intelligent code. The processor computer device 12 may instruct the user to scan the barcode on the chit/physical card with the user device 14, or the chit (or physical card) or endcap may display instructions instructing the user to do so. Once the user scans the barcode with the user device 14, the processor computer device 12 associates the intelligent code scan with the barcode scan, for example, to prepare the NFT in the NFT shopping cart for redemption. The processor computer device 12, the endcap, the chit (or physical card), or combinations thereof, may instruct the user to remove the chit (or physical card) from the endcap display and to scan (or have scanned) the chit (or physical card) at a point-of-sale device of a merchant (e.g., merchant computer device 16). The purchase is processed as described hereinabove (e.g., by processor computer device 12), and a payment verification is received by the processor computer device 12. The processor computer device 12 may then unpause the NFT shopping cart. The processor computer device 12 may then add the NFT to an e-wallet of the user, provide the NFT to the user via user device 14 or otherwise, or combinations thereof.

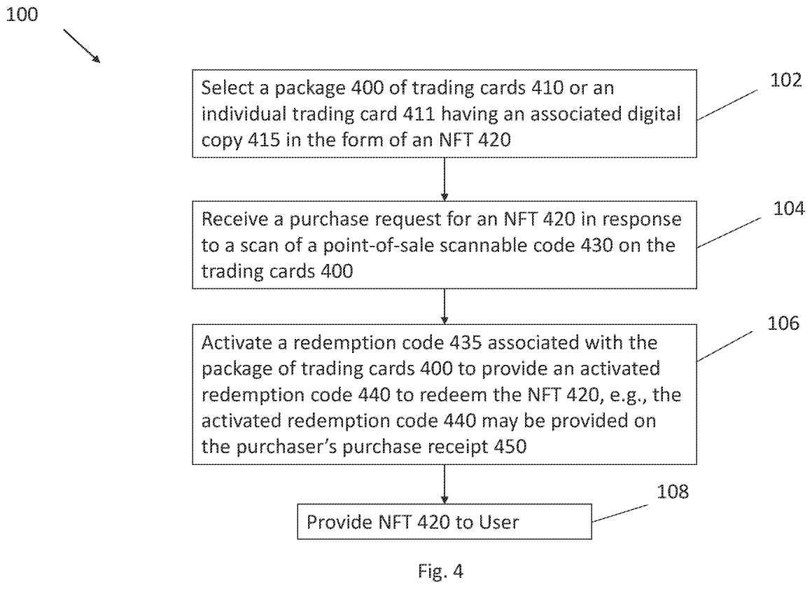

Referring now to FIG. 4, another method 100 for purchasing an NFT includes selecting a physical object for purchase wherein the physical object is associated with a digital representation of the physical object, In an embodiment the physical object for purchase may be packaged and/or otherwise combined for purchase with one or a plurality of other physical objects, wherein the one, the plurality of other physical objects, or certain of the plurality of other physical objects may also be associated with their own digital representations. For example, in an embodiment, the method 100 comprises selecting a package of trading cards 400 from a retailer, at block 102. The package of trading cards 400 includes a plurality of trading cards 410, and at least one of, multiple, or each of the plurality of trading cards has an associated digital version (e.g., copy) 415 in the form of an NFT 420. A point-of-sale scannable code 430 is printed or otherwise displayed, for example with a sticker, on the package of trading cards 400. The point-of-sale scannable code 430 may comprise vendor product information (e.g., UPC information) along with activation information for the NFT 420. In some embodiments, the point-of-sale scannable code 430 can be printed or otherwise displayed, for example with a sticker, directly on a single trading card 411 that is not sold in a package. In such an embodiment, an NFT is only purchased for the single trading card 411. The point-of-sale scannable code 430 is unique to the package of trading cards 400, and thereby unique to each NFT 420 associated with the trading cards 410 in the package 400. The point-of-sale scannable code 430 can be encoded in any one of a barcode; a QR code; an arrangement of numerals, letters, symbols, images, and/or colors; an electromagnetic signal (e.g., near field communication (“NFC”), infrared, radio frequency identification (“RFID”); a mechanical wave (e.g., sound); or combinations thereof.

At block 104, a processor computing device receives a purchase request for the package of trading cards 400 in response to a scan of the point-of-sale scannable code 430 or provision of other identifying information for the package of trading cards 400 at the point-of-sale (e.g., a barcode which only comprises UPC-type information). That is, the purchaser takes the package of trading cards 400 to a point-of-sale within the retailer and purchases the package of trading cards 400.

At block 106, during the purchasing transaction, the point-of-sale scannable code 430 is scanned, and upon confirmation of payment for the package of trading cards 400, the processor computer device activates a redemption code 435 associated with the package of trading cards 400 and/or NFT 420 and provides, and/or otherwise makes available to the purchaser, an activated redemption code 440 for the NFTs associated with the package of trading cards 400, for example the activated redemption code 440 may be the same point-of-sale scannable code 430 already associated with the package of trading cards 400 (or an individual trading card 411) or the activated redemption code 440 may be another different and/or unique code which is provided to the purchaser upon confirmation of payment, e.g., the activated redemption code 440 may be provided on the purchaser's purchase receipt 450. In one embodiment, a single activated redemption code 440 is provided for every NFT 420 associated with the trading cards 410. In another embodiment, a unique activated redemption code 440 is provided for each NFT 420 that corresponds to a trading card 411 in the package 400. For example, if the package contains 10 trading cards, each corresponding to one of 10 NFTs, the processor computer device will provide 10 activated redemption codes, each redeemable for one of the NFTs.

As noted above, the unique activated redemption code 440 can be provided to the purchaser as part of the purchased package of trading cards 400, as part of a purchased individual trading card 411, as part of the purchaser's purchase receipt 450, or combinations thereof. Alternatively, the activated redemption code 440 may be provided to the purchaser via email, text, or other electronic conveyance. For example, the activated redemption code 440 can be delivered to the purchaser's e-wallet as described above. In some embodiments, a hard copy of the activated redemption code 440 can be provided to the purchaser by printing the activated redemption code 440 on a physical receipt or other document. The activated redemption code 440 can be any one of a barcode; a QR code; an arrangement of numerals, letters, symbols, images, and/or colors; an electromagnetic signal (e.g., near field communication (“NFC”), infrared, radio frequency identification (“RFID”); a mechanical wave (e.g., sound); or combinations thereof.

At block 106, the purchaser accesses an NFT providing website (or other NFT available location, e.g. an electronic wallet) to redeem the activated redemption code 440 for the NFT(s) associated with package of trading cards 400, the trading cards 410, or the individual trading card 411. In an embodiment, the activated redemption code 440 can be redeemed on a website accessed by the purchaser with a personal computer, mobile device, e-wallet, or the like. In response to purchaser's request to redeem the activated redemption code 440 or codes, the processor computer device, at block 108, provides the NFT 420 or NFTs to the user. For example, the NFT 420 or NFTs can be delivered to the purchaser's e-wallet, as described above.

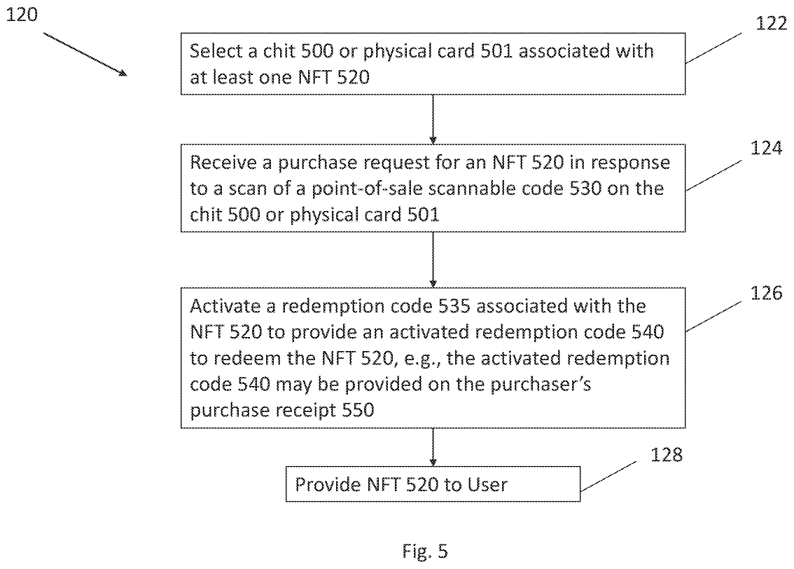

Referring to FIG. 5, another method 120 for purchasing an NFT includes providing a point-of-sale scannable code 530 configured to facilitate the purchase of an NFT 520 at a point of sale for initiating an NFT purchase transaction. In an embodiment, the point-of-sale scannable code 530 may be displayed on a merchant's shelving, endcap, or other presentation component and be configured to be captured or otherwise selected for presentation at a point of sale, e.g., the point-of-sale scannable code 530 may be physically printed on a retailer's merchant's shelving, endcap, or other presentation component or may be electronically displayed or provided at those same locations. In an embodiment, a purchaser may scan, photograph, or otherwise capture the point-of-sale scannable code 530 via a purchaser's device, e.g., a smartphone, tablet, watch, or other device, and then display or provide the point-of-sale scannable code 530 to the point of sale via the purchaser's device. In an embodiment, the point-of-sale scannable code 530 may comprise a physical object. In an embodiment, the physical object is fixed to the merchant's shelving, endcap, or other presentation component. In an embodiment, the physical object is removable from the merchant's shelving, endcap, or other presentation component and transportable to the point of sale by the purchaser. In an embodiment, the physical object comprising the point-of-sale scannable code 530 may be a chit 500, a manufactured card 501, an electronic display, or other physical object configured to display or provide the point-of-sale scannable code 530. In an embodiment, the physical object emits the point-of-sale scannable code 530 via an electromagnetic signal. In an embodiment, the electromagnetic signal comprises near field communication, infrared, radio frequency identification, or combinations thereof. Herein the method 120 will be described with relation to a chit 500. In some embodiments, the chit 500 is associated with a single NFT 520. In other embodiments, the chit 500 is associated with a plurality of NFTs that are sold as a package 510. A point-of-sale scannable code 530 is printed or otherwise displayed, for example with a sticker, on the chit 500. The point-of-sale scannable code 530 may comprise vendor product information (e.g., UPC information) along with activation information for the NFT 420. The point-of-sale scannable code 530 is unique to the chit 500, and thereby unique to the NFT 520 or NFTs associated with the chit 500. The point-of-sale scannable code 530 can be encoded in any one of a barcode; a QR code; an arrangement of numerals, letters, symbols, images, and/or colors; an electromagnetic signal (e.g., near field communication (“NFC”), infrared, radio frequency identification (“RFID”); a mechanical wave (e.g., sound); or combinations thereof.

At block 124, a processor computing device receives a purchase request for the NFT 520 in response to a scan of the point-of-sale scannable code 530 on the chit 500 or provision of other identifying information for the chit 500 at the point-of-sale (e.g., a barcode which only comprises UPC-type information). That is, the purchaser takes the chit 500 to a point-of-sale within the retailer and purchases the NFT 520 or NFTs associated with the chit 500.

At block 126, during the purchasing transaction, the point-of-sale scannable code 530 is scanned, and upon confirmation of payment for the NFT 520 or NFTs associated with the chit 500, the processor computer device activates a redemption code 535 associated with the NFT and provides, and/or otherwise makes available to the purchaser, an activated redemption code 540 for the NFT 520 or NFTs associated with the chit 500, for example the activated redemption code 540 may be the same point-of-sale scannable code 530 already associated with the chit 500 or the activated redemption code 540 may be another different and/or unique code which is provided to the purchaser upon confirmation of payment, e.g., the activated redemption code 540 may be provided on the purchaser's purchase receipt 550, In one embodiment, a single activated redemption code 540 is provided for every NFT 520 associated with the chit 500. In another embodiment, a unique activated redemption code 540 is provided for each NFT 520 associated with the chit 500. For example, if the chit 500 is associated with 10 NFTs, the processor computer device will provide 10 intelligent codes, each redeemable for one of the NFTs.

As noted above, the unique activated redemption code 540 can be transferred to the purchaser as part of the chit 500, as part of the purchaser's purchase receipt 450, or combinations thereof. Alternatively, the activated redemption code 540 may be provided to the purchaser via email, text, or other electronic conveyance. For example, the activated redemption code can be delivered to the purchaser's e-wallet as described above. In some embodiments, a hard copy of the activated redemption code 540 can be provided to the purchaser by printing the activated redemption code 540 on a physical receipt or other document. The activated redemption code 540 can be any one of a barcode; a QR code; an arrangement of numerals, letters, symbols, images, and/or colors; an electromagnetic signal (e.g., near field communication (“NFC”), infrared, radio frequency identification (“RFID”); a mechanical wave (e.g., sound); or combinations thereof.

At block 126, the purchaser accesses an NFT providing website (or other NFT available location, e.g. an electronic wallet) to redeem the activated redemption code 540 for the NFT(s) associated the chit 500. In an embodiment, the activated redemption code 540 can be redeemed on a website accessed by the purchaser with a personal computer, mobile device, e-wallet, or the like. In response to purchaser's request to redeem the activated redemption code 540, the processor computer device, at block 128, provides the NFT 520 or NFTs to the user. For example, the NFT 520 or NFTs can be delivered to the purchaser's e-wallet, as described above.

In embodiments of the disclosed systems and methods can be used or for the direct benefit of the user of the system and methods.

In a first case, a method performed by a processor computer device having a processor and executable instructions stored on a non-transitory computer readable medium which, when executed by the processor, causes the processor computer device to perform the method, the method comprising:
receiving, by the processor computer device, from a user device, a purchase request for a non-fungible token, wherein the non-fungible token is available from a digital shopping site;
transforming, by the processor computer device, information from the purchase request into a point-of-sale scannable barcode, wherein the point-of-sale scannable barcode comprises purchase information of the non-fungible token for purchasing the non-fungible token;
providing, by the processor computer device, the point-of-sale scannable barcode to the user device in response to the request;
receiving, by the processor computer device, a purchase verification for the non-fungible token, wherein the purchase verification is subsequent to, and generated in response to, a point-of-sale scan of the point-of-sale scannable barcode displayed on the user device at a retailer point-of-sale; and
providing, by the processor computer device, the non-fungible token to a user or a third-party recipient in response to receiving the purchase verification.

In a second case, method of the first case, wherein the digital shopping site comprises a plurality of non-fungible token from a plurality of retailers.

In a third case, the method of the second case, further comprising validating the purchase request of the non-fungible token.

In a fourth case, the method of the third case, wherein validation comprises providing a code to the user device that is provided to the processor computer device and determining the code is valid.

In a fifth case, the method of the first case, wherein the purchase request is received from the user that has accessed the digital shopping site by scanning an intelligent code with the user device.

In a sixth case, the method of the fifth case, wherein the intelligent code comprises at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof.

In a seventh case, the method of the fifth case, wherein the intelligent code is located at a retailer store which comprises the retailer point of sale.

In an eighth case, the method of the first case, wherein the non-fungible token is delivered digitally to an email or text number provided by the user.

In a ninth case, the method of the first case, further comprising receiving a purchase verification for the non-fungible token.

In a tenth case, the method of the first case, wherein the point-of-sale scannable barcode is unique to the non-fungible token.

In an eleventh case, a system comprising a computer device having a processor and executable instructions stored on a non-transitory computer readable medium, wherein the execution of the executable instructions configures the system to:
receive a scan of an intelligent code at a retailer store from a user device, wherein the scan of the intelligent code allows a user of the user device access to digital shopping site containing a plurality of electronic non-fungible tokens;
receive a purchase request for a non-fungible token from the digital shopping site from a user device;
transform information from the purchase request into a point-of-sale scannable barcode, wherein the point-of-sale scannable barcode comprises purchase information of the non-fungible token for purchasing the non-fungible token;
provide the point-of-sale scannable barcode to the user device in response to the request;
receive a purchase verification for the non-fungible token, wherein the purchase verification is subsequent to, and generated in response to, a point-of-sale scan of the point-of-sale scannable barcode displayed on the user device; and
provide the non-fungible token to the user of the user device or a third-party recipient in response to receiving the purchase verification.

In a twelfth case, the system of the eleventh case, wherein the digital shopping site comprises a plurality of retailers.

In a thirteenth case, the system of the eleventh case, further configured to receive a purchase verification for the non-fungible token.

In a fourteenth case, the system of the eleventh case, further configured to receive a purchase request from the user that has accessed the digital shopping site by scanning an intelligent code with the user device.

In a fifteenth case, the system of the fourteenth case, wherein the intelligent code comprises at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof.

In a sixteenth case, the system of the fourteenth case, wherein the intelligent code is on an endcap, a physical card, a card package, a chit, or combinations thereof.

In a seventeenth case, the system of the eleventh case, wherein the point-of-sale scannable barcode is unique to the non-fungible token.

In an eighteenth case, the system of eleventh case, further configured to deliver the non-fungible token digitally to an email or text number provided by the user.

In a nineteenth case, the system of the eleventh case, further configured to provide a code to the user device that is provided to the processor computer device.

In a twentieth case, the system of the nineteenth case, further configured to determine the code is valid.

In a twenty-first case, a method performed by a processor computer device, the processor computer device having a processor and executable instructions stored on a non-transitory computer readable medium which, when executed by the processor, causes the processor computer device to perform the method, the method comprising:
receiving, by the processor computer device, a purchase request, in response to a scan of a point-of-sale scannable code, wherein the purchase request comprises a physical object request and a non-fungible token request, and, wherein a non-fungible token associated with the non-fungible token request includes a digital version of the a physical object associated with the physical object request,
verifiying, by the processor computer device, payment for the purchase request,
activating, by the processor computer device, a redemption code associated with the non-fungible token to produce an activated redemption code; and
providing, by the processor computer device, the activated redemption code redeemable for the non-fungible token.

In a twenty-second case, the method of the twenty-first case, wherein the processor computer device provides the non-fungible token to a user in response to activation of the activated redemption code.

In a twenty-third case, the method of the twenty-first case, wherein, upon verifying payment for the purchase transaction, the processor computer device converts the point-of-sale scannable code into the activated redemption code.

In a twenty-fourth case, the method of the twenty-first case, wherein the activated redemption code is unique to the non-fungible token.

In a twenty-fifth case, the method of the twenty-first case, wherein the activated redemption code comprises at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof.

In a twenty-sixth case, the method of the twenty-first case, wherein the point-of-sale scannable code comprises at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof.

In a twenty-seventh case, the method the twenty-first case, wherein the physical object comprises a trading card.

In a twenty-eighth case, the method of the twenty-seventh case, wherein the point-of-sale scannable code is provided on a package of a plurality of trading cards and wherein the activated redemption code is redeemable for a plurality of non-fungible tokens, wherein each of the plurality of non-fungible tokens is a digital version of one of the plurality of trading cards.

In a twenty-ninth case, the method of the twenty-seventh case, wherein the point-of-sale scannable code is provided on a package of a plurality of trading cards, and the method includes providing, by the processor computer device, a plurality of unique activated redemption codes, wherein each of the plurality of unique activated redemption codes is redeemable for one of a plurality of non-fungible tokens, wherein each of the plurality of non-fungible tokens is a digital version of one of the plurality of trading cards.

In a thirtieth case, a method performed by a processor computer device, the processor computer device having a processor and executable instructions stored on a non-transitory computer readable medium which, when executed by the processor, causes the processor computer device to perform the method, the method comprising:
receiving, by the processor computer device, a purchase request for a non-fungible token in response to a scan of a point-of-sale scannable code,
verifiying, by the processor computer device, payment for the non-fungible token,
activating, by the processor computer device, a redemption code associated with the non-fungible token to produce an activated redemption code; and
providing, by the processor computer device, the activated redemption code redeemable for the non-fungible token.

In a thirty-first case, the method of the thirtieth case, wherein the processor computer device provides the non-fungible token to a user in response to activation of the redemption code.

In a thirty-second case, the method of the thirtieth case, wherein, upon verifying payment for non-fungible token, the processor computer device converts the point-of-sale scannable code into the activated redemption code.

In a thirty-third case, the method of the thirtieth case, wherein the redemption code is unique to the non-fungible token.

In a thirty-fourth case, the method of the thirtieth case, wherein the redemption code comprises at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof.

In a thirty-fifth case, the method of the thirtieth case, wherein the point-of-sale scannable code comprises at least one of a barcode; a QR code; an arrangement of numerals, letters, symbols, images, and/or colors; an electromagnetic signal (e.g., near field communication (“NFC”), infrared, radio frequency identification (“RFID”)); a mechanical wave (e.g., sound); or combinations thereof.

In a thirty-sixth case, the method of the thirtieth case, wherein the point-of-sale scannable code is associated with a plurality of non-fungible tokens, and wherein the activated redemption code is redeemable for the plurality of non-fungible tokens.

In a thirty-seventh case, the method of the thirtieth case, wherein the point-of-sale scannable code is associated with a plurality of non-fungible tokens, and the method includes further providing, by the processor computer device, a plurality of unique activated redemption codes, wherein each of the plurality of unique activated redemption codes is redeemable for one of a plurality of non-fungible tokens.

In a thirty-eighth case, the method of the thirtieth case, wherein the point-of-sale scannable code is displayed on a physical object.

In a thirty-ninth case, the method of the thirty-eighth case, wherein the physical object is selected from a group consisting of a chit, a manufactured card, an electronic display, or combinations thereof.

In a fortieth case, the method of the thirtieth case, wherein the point-of-sale scannable code is provided by a physical object.

In a forty-first case, the method of the fortieth case, wherein the physical object comprises a device which emits an electromagnetic signal.

In a forty-second case, the method of the forty-first case, wherein the electromagnetic signal is selected from a group consisting of near field communication, infrared, radio frequency identification, or combinations thereof.

1. A method performed by a processor computer device having a processor and executable instructions stored on a non-transitory computer readable medium which, when executed by the processor, causes the processor computer device to perform the method, the method comprising:
receiving, by the processor computer device, from a user device, a purchase request for a non-fungible token, wherein the non-fungible token is available from a digital shopping site;
transforming, by the processor computer device, information from the purchase request into a point-of-sale scannable barcode, wherein the point-of-sale scannable barcode comprises purchase information of the non-fungible token for purchasing the non-fungible token;
providing, by the processor computer device, the point-of-sale scannable barcode to the user device in response to the request;
receiving, by the processor computer device, a purchase verification for the non-fungible token, wherein the purchase verification is subsequent to, and generated in response to, a point-of-sale scan of the point-of-sale scannable barcode displayed on the user device at a retailer point-of-sale; and
providing, by the processor computer device, the non-fungible token to a user or a third-party recipient in response to receiving the purchase verification.

2. The method of claim 1, wherein the digital shopping site comprises a plurality of non-fungible token from a plurality of retailers.

3. The method of claim 2, further comprising validating the purchase request of the non-fungible token.

4. The method of claim 3, wherein validation comprises providing a code to the user device that is provided to the processor computer device and determining the code is valid.

5. The method of claim 1, wherein the purchase request is received from the user that has accessed the digital shopping site by scanning an intelligent code with the user device.

6. The method of claim 5, wherein the intelligent code comprises at least one of a barcode; a QR code; an arrangement of numerals, letters, symbols, images, and/or colors; an electromagnetic signal (e.g., near field communication (“NFC”), infrared, radio frequency identification (“RFID”));
a mechanical wave (e.g., sound); or combinations thereof.

7. The method of claim 5, wherein the intelligent code is located at a retailer store which comprises the retailer point of sale.

8. The method of claim 1, wherein the non-fungible token is delivered digitally to an email or text number provided by the user.

9. The method of claim 1, further comprising receiving a purchase verification for the non-fungible token.

10. The method of claim 1, wherein the point-of-sale scannable barcode is unique to the non-fungible token.

11. A system comprising a computer device having a processor and executable instructions stored on a non-transitory computer readable medium, wherein the execution of the executable instructions configures the system to:
receive a scan of an intelligent code at a retailer store from a user device, wherein the scan of the intelligent code allows a user of the user device access to digital shopping site containing a plurality of electronic non-fungible tokens;
receive a purchase request for a non-fungible token from the digital shopping site from a user device;
transform information from the purchase request into a point-of-sale scannable barcode, wherein the point-of-sale scannable barcode comprises purchase information of the non-fungible token for purchasing the non-fungible token;
provide the point-of-sale scannable barcode to the user device in response to the request;
receive a purchase verification for the non-fungible token, wherein the purchase verification is subsequent to, and generated in response to, a point-of-sale scan of the point-of-sale scannable barcode displayed on the user device; and
provide the non-fungible token to the user of the user device or a third-party recipient in response to receiving the purchase verification.

12. The system of claim 11, wherein the digital shopping site comprises a plurality of retailers.

13. The system of claim 11, further configured to receive a purchase verification for the non-fungible token.

14. The system of claim 11, further configured to receive a purchase request from the user that has accessed the digital shopping site by scanning an intelligent code with the user device.

15. The system of claim 14, wherein the intelligent code comprises at least one of a barcode; a QR code; an arrangement of numerals, letters, symbols, images, and/or colors; an electromagnetic signal (e.g., near field communication (“NFC”), infrared, radio frequency identification (“RFID”));
a mechanical wave (e.g., sound); or combinations thereof.

16. The system of claim 14, wherein the intelligent code is on an endcap, a physical card, a card package, a chit, or combinations thereof.

17. The system of claim 11, wherein the point-of-sale scannable barcode is unique to the non-fungible token.

18. The system of claim 11, further configured to deliver the non-fungible token digitally to an email or text number provided by the user.

19. The system of claim 11, further configured to provide a code to the user device that is provided to the processor computer device.

20. A method performed by a processor computer device, the processor computer device having a processor and executable instructions stored on a non-transitory computer readable medium which, when executed by the processor, causes the processor computer device to perform the method, the method comprising:
receiving, by the processor computer device, a purchase request, in response to a scan of a point-of-sale scannable code, wherein the purchase request comprises a physical object request and a non-fungible token request, and, wherein a non-fungible token associated with the non-fungible token request includes a digital version of the a physical object associated with the physical object request,
verifiying, by the processor computer device, payment for the purchase request,
activating, by the processor computer device, a redemption code associated with the non-fungible token to produce an activated redemption code; and
providing, by the processor computer device, the activated redemption code redeemable for the non-fungible token.
